(19) United States
(12) Patent Application Publication
(10) Pub. No.: US 2025/0033221 A1
(43) Pub. Date: Jan. 30, 2025

(54) FOOT FORCE ACQUISITION APPARATUS AND QUADRUPED ROBOT USING THE SAME

(71) Applicant: HangZhou YuShu TECHNOLOGY CO.,LTD., Hangzhou (CN)

(72) Inventor: Xingxing WANG, Hangzhou (CN)

(21) Appl. No.: 18/917,403

(22) Filed: Oct. 16, 2024

Related U.S. Application Data
(63) Continuation-in-part of application No. 17/639,163, filed on Feb. 28, 2022.

(30) Foreign Application Priority Data
Aug. 28, 2019 (CN) 201921416157. 7

(51) Int. Cl. B25J 13/08; B62D 57/032; G01L 1/02; G01L 5/00

(52) U.S. Cl. CPC B25J 13/085; B62D 57/032; G01L 1/02; G01L 5/0038

(57) ABSTRACT

A foot force acquisition apparatus includes a first connecting rod, a pressure signal acquisition board, a second connecting rod rotatably connected with the first connecting rod, and an air tube provided in the first connecting rod and the second connecting rod. An end portion of the second connecting rod is fixedly provided with an elastic foot pad. An air chamber is provided in the elastic foot pad. One end of the air tube is connected with the air chamber. The other end is connected with the pressure signal acquisition board. By providing the pressure signal acquisition board and providing the air chamber in the foot, the air tube spans a joint formed by the first connecting rod and the second connecting rod to acquire the internal pressure value of the air chamber, thus achieving the advantages of simple structure, low cost and high reliability.

### CROSS-REFERENCE TO RELATED APPLICATIONS

This application is a Continuation-in-Part of co-pending application Ser. No. 17/639,163 filed on Feb. 28, 2022, which is a U.S. National Stage of International Application No. PCT/CN2020/123185 filed on Oct. 23, 2020, for which priority is claimed under 35 U.S.C. § 120; and this application claims priority of application No. 201921416157.7 filed in China on Aug. 28, 2019, under 35 U.S.C. § 119; the entire contents of all of which are hereby incorporated by reference.

### BACKGROUND OF THE INVENTION

### Field of the Invention

The present application relates to the technical field of robot equipment, in particular to a novel foot force acquisition apparatus and a quadruped robot using the same.

### Brief Description of the Related Art

At present, the feet of the four legs of a quadruped robot are generally equipped with force sensors, and then electrical signals acquired by the force sensors are transmitted to a main control board for processing through cables. In this process, the cables need to pass through a second connecting rod, knee joint and a first connecting rod to the main control board, so that the electrical structure is relatively complex.

The traditional force sensor using a strain gauge or pressure sensitive resistor or capacitor is easily damaged when the foot is subjected to impact force, and its structure is complex. On the other hand, part of the electrical cable passes through a rotating connection (joint) between the first connecting rod and the second connecting rod. Due to reciprocating bending in the working process of the knee joint, this part of the electrical cable is very prone to fatigue damage.

### SUMMARY OF THE INVENTION

In order to overcome the shortcomings of the prior art, a first purpose of the present application is to provide a novel foot force acquisition apparatus, which has the advantages that the foot force acquisition mode is simple, the force signal acquisition and transmission do not need electrical cables, the structure is simple, the cost is low, and it is not easy to cause faults.

A second purpose of the present application is to provide a quadruped robot including the foot force acquisition apparatus, which has the advantages that the foot force acquisition mode is simple, the force signal acquisition and transmission do not need electrical cables, the structure is simple, the cost is low, and it is not easy to cause faults.

The first purpose of the present application is realized by adopting the following technical solution:
A novel foot force acquisition apparatus includes a first connecting rod, a pressure signal acquisition board, a second connecting rod rotatably connected with the first connecting rod, and an air tube; an end portion of the second connecting rod is fixedly provided with an elastic foot pad, the elastic foot pad is provided with an air chamber, one end of the air tube is communicated with the air chamber, and the other end is connected with the pressure signal acquisition board; the elastic foot pad contacts the ground to deform and squeeze the air chamber, and the pressure signal acquisition board measures the change of the internal pressure value of the air chamber through the air tube, so as to realize the signal acquisition of the force on the elastic foot pad.

Further, according to the change of air pressure, the force on the elastic foot pad may be obtained. The air chamber may be directly designed in the original elastic foot pad without adding additional parts. The force acquisition structure and mode are simple and reliable, and the cost is low.

Further, an end portion of the second connecting rod is provided with a foot pad mounting base and the elastic foot pad is fixedly provided on the foot pad mounting base. The elastic foot pad and the foot pad mounting base may be assembled together in advance to form a foot assembly, which is then fixedly connected to the second connecting rod, so as to facilitate mounting and replacement.

Further, the air tube is provided along the first connecting rod and the second connecting rod, and the air tube spans a rotating joint formed by the first connecting rod and the second connecting rod; the pressure signal acquisition board is provided on the first connecting rod or other components connected with the first connecting rod. The air tube is used to directly span the rotating joint, thus preventing the electrical cable that is more prone to fatigue damage from spanning the rotating joint, and improving the reliability. After the sensor is moved up to the inside of the first connecting rod or further moved up to other components, the sensor is not influenced by the external environment, thus reducing the probability of sensor failure. In addition, the traditional electrical cable is not required to bypass the joint, but the elastic air tube is used to bypass the joint, thus reducing fatigue damage in the process of reciprocating rotation of the joint.

Further, the air tube and the air chamber are in an integrated or split structure; the air tube and the air chamber are capable of being filled with gas or liquid. The filler in the air tube and air chamber may be selected according to the actual working temperature, the detected force and the like.

Further, a tube groove for placing the air tube is provided in the foot pad mounting base. The tube groove is provided in the foot pad mounting base, thus facilitating the communication between the air tube and the air chamber, so that the structure is simple and reliable.

Further, the first connecting rod or the second connecting rod is provided with a mounting groove or a mounting cavity for placing the air tube. The air tube on the first connecting rod and the second connecting rod is easy to swing with the rotation of the second connecting rod relative to the first connecting rod. After multiple reciprocating swings, the air tube is easy to move. Therefore, the mounting groove or mounting cavity is provided to fix the air tube, so that the structure is simple and reliable and the integration level is high.

Further, an elastic member capable of pulling the air tube is provided in the first connecting rod or the second connecting rod, one end of the elastic member is provided with a fastening ring I, and the other end is provided with a fastening ring II;
the fastening ring I is fixed to an inner wall of the second connecting rod through a screwing column and a screwing member;
a blind hole with a thread is provided in the screwing column, and the screwing column is integrally formed with the second connecting rod;
the screwing member includes a large end and a small end;
the large end has a diameter larger than the diameter of the fastening ring I, and is used for limiting the fastening ring;
the small end is a rod-shaped structure, is provided with a thread on an outer wall surface, and has a diameter smaller than the diameter of the fastening ring, so that the small end of the screwing member is capable of passing through the fastening ring I and being tightened in the blind hole of the screwing column to form a fixing structure I used for fixing one end of the elastic member to the second connecting rod;
the fastening ring II is fixed to the air tube through a bent body and a pinning member;
the bent body is a sheet-like structure, and after bending, forms a wrapping cavity for wrapping the air tube and an assembling space for assembling the fastening ring II; two pinning holes capable of running through each other are provided in an edge of the sheet-like structure, and includes a perforation hole I and a perforation hole II;
the pinning member sequentially passes through the perforation hole I, the fastening ring II and the perforation hole II by riveting to form a fixing structure II used for fixing the other end of the elastic member to the air tube;
or, the pinning member includes a large end and a column body, and the large end has a diameter larger than the diameter of the perforation hole I. an outer wall surface of the column body is provided with a thread, and the column body has a diameter respectively smaller than the diameters of the perforation hole I, the fastening ring II and the perforation hole II; the column body sequentially passes through the perforation hole I, the fastening ring II and the perforation hole II, and a nut is screwed onto an outer wall surface of the perforation hole II to form a fixing structure II used for fixing the other end of the elastic member to the air tube, so that a portion of the air tube located at the rotating joint is kept always in a tensioned state during the rotation of the second connecting rod relative to the first connecting rod.

The elastic member is provided, so that the air tube is always kept in a regular tensioned state during the rotation of the second connecting rod relative to the first connecting rod, rather than randomly twists or shakes, the structure is simple and reliable, and the fatigue life of the air tube spanning the rotating joint is further improved. In addition, by fixing the elastic member through the screwing column and the bent body, the fixing structure is safer, more reliable, and less prone to loosening.

The bent body is made of a metal, plastic or rubber material.

Further, the elastic member is a tension spring, a compression spring, a torsion spring, elastic silica gel or elastic plastic.

In order to achieve one of the above purposes, the present utility model adopts a second technical solution as follows:
A novel foot force acquisition apparatus includes a first connecting rod, a pressure signal acquisition board, a second connecting rod rotatably connected with the first connecting rod, and an air tube; an end portion of the second connecting rod is fixedly provided with an elastic foot pad, the elastic foot pad is provided with an air chamber, one end of the air tube is communicated with the air chamber, and the other end is connected with the pressure signal acquisition board; the elastic foot pad contacts the ground to deform and squeeze the air chamber, the pressure signal acquisition board measures the change of the internal pressure value of the air chamber through the air tube, so as to realize the signal acquisition of the force on the elastic foot pad;
a mounting groove or mounting cavity for placing the air tube is provided in the first connecting rod or the second connecting rod;
an elastic member capable of pulling the air tube is provided in the second connecting rod, one end of the elastic member is bonded to the second connecting rod through a first adhesive tape, and the other end of the elastic member is bonded to the air tube through a second adhesive tape, so that a portion of the air tube located at the rotating joint is kept always in a tensioned state during the rotation of the second connecting rod relative to the first connecting rod;
the first adhesive tape is a sheet-like structure, one part of an adhesive surface of the first adhesive tape is capable of being bonded to an outer surface of the elastic member to form a wrapping structure I, and the other part of the adhesive surface of the first adhesive tape is capable of being bonded to an inner wall surface of the second connecting rod to form a fixing structure I used for fixing one end of the elastic member 12;
the second adhesive tape is a sheet-like structure, one part of an adhesive surface of the second adhesive tape is capable of being bonded to the outer surface of the elastic member to form a wrapping structure II, and the other part of the adhesive surface of the second adhesive tape is capable of being bonded to an outer wall surface of the air tube to form a fixing structure II used for fixing the other end of the elastic member.

In the present utility model, by providing the elastic member, the air tube is kept always in a tensioned and regular state during the rotation of the second connecting rod relative to the first connecting rod, rather than randomly twists or shakes The structure is simple and reliable, thus further improving the fatigue life of the air tube that spans the rotating joint. By fixing the elastic member through the adhesive tapes, the solution is simple and practical, and the manufacturing cost is low.

The second purpose of the present application is realized by adopting the following technical solution:
A quadruped robot includes the novel foot force acquisition apparatus.

In order to realize the first purpose of the present application, another technical solution is adopted:
A novel foot force acquisition apparatus includes a second connecting rod and an air tube, an end portion of the second connecting rod is fixedly provided with an elastic foot pad, the elastic foot pad is provided with an air chamber, and one end of the air tube is communicated with the air chamber; the elastic foot pad contacts the ground to deform and squeeze the air chamber, so as to realize the signal acquisition of the force on the elastic foot pad.

In the present application, since the air chamber is provided in the foot and the internal pressure value of the air chamber is acquired through the air tube, there is no need to provide a sensor in the foot, thus reducing the probability of sensor failure. Since the air tube is used for pressure signal acquisition and transmission, the foot and the second connecting rod do not need any electronic circuit at all, thus avoiding cable wear that influences the acquisition and transmission of pressure signals. Relatively, the signal acquisition in the present application is more reliable and stable.

### Beneficial Effects of the Application

1. In the novel foot force acquisition apparatus provided by the present application, for the acquisition of signals, by providing the force signal acquisition board and providing the air chamber in the foot, the internal pressure value of the air chamber is acquired through the air tube and there is no need to provide a sensor in the foot, thus reducing the probability of sensor failure. Since the air tube is used for pressure signal acquisition and transmission, the foot and the second connecting rod do not need any electronic circuit at all, thus avoiding cable wear that influences the acquisition and transmission of pressure signals. Relatively, the signal acquisition in the present application is more reliable and stable.
2. The quadruped robot provided by the present application includes the foot force acquisition apparatus. For the acquisition of signals, by providing the force signal acquisition board and providing the air chamber in the foot, the internal pressure value of the air chamber is acquired through the air tube and there is no need to provide a sensor in the foot, thus reducing the probability of sensor failure. Since the air tube is used for pressure signal acquisition and transmission, the foot and the second connecting rod do not need any electronic circuit at all, thus avoiding cable wear that influences the acquisition and transmission of pressure signals. Relatively, the signal acquisition in the present application is more reliable and stable.
3. In the present utility model, by providing the elastic member, the air tube is kept always in a tensioned and regular state during the rotation of the second connecting rod relative to the first connecting rod, rather than randomly twists or shakes The structure is simple and reliable, thus further improving the fatigue life of the air tube that spans the rotating joint.

### BRIEF DESCRIPTION OF THE DRAWINGS

FIG. 1 is a schematic view of an overall structure according to the present application.

FIG. 2 is a cross-sectional view according to the present application.

FIG. 3 is an A-A sectional view according to the present application.

FIG. 4 is a B-B sectional view according to the present application.

FIG. 5 is a schematic structural diagram of a fixing structure for an elastic member according to the present utility model;

FIG. 6 is a schematic structural diagram of an elastic member according to the present utility model;

FIG. 7 is a partially enlarged schematic diagram of a fixing structure for an elastic member according to the present utility model;

FIG. 8 is a partially enlarged schematic diagram of a bent body according to the present utility model.

In the drawings, 1—first connecting rod; 2—second connecting rod; 4—air tube; 5—elastic foot pad; 6—air chamber; 7—foot pad mounting base; 8—tube groove; 9—rotating joint; 10—mounting groove; 11—pressure signal acquisition board; 12—elastic member; 13—screwing column; 14—screwing member; 15—bent body; 16.—pinning member; 121—fastening ring I; 122—fastening ring II; 151—pinning hole; 152—assembling space.

### DETAILED DESCRIPTION OF THE PREFERRED EMBODIMENTS

The present application will be further described below in combination with the specific embodiments with reference to the drawings. It should be noted that on the premise of no conflict, the embodiments or technical features described below may be combined freely to form new embodiments.

It should be noted that when two components are “fixedly connected”, the two components may be directly connected or there may be an intermediate component. Unless otherwise defined, all technical and scientific terms used herein have the same meanings as those generally understood by those skilled in the technical field of the present application. The terms used herein are only for the purpose of describing the specific embodiments and are not intended to limit the present application.

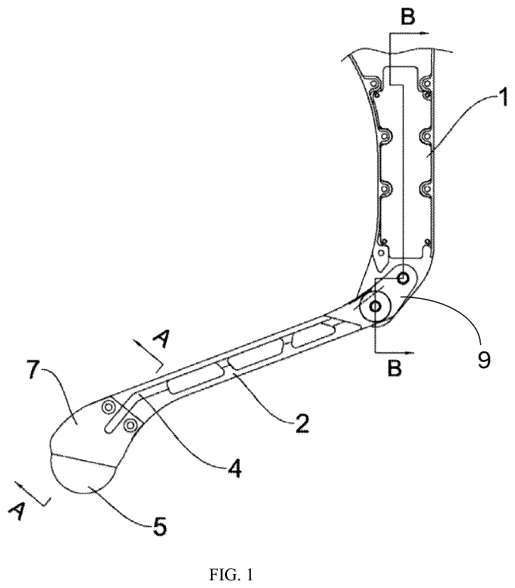

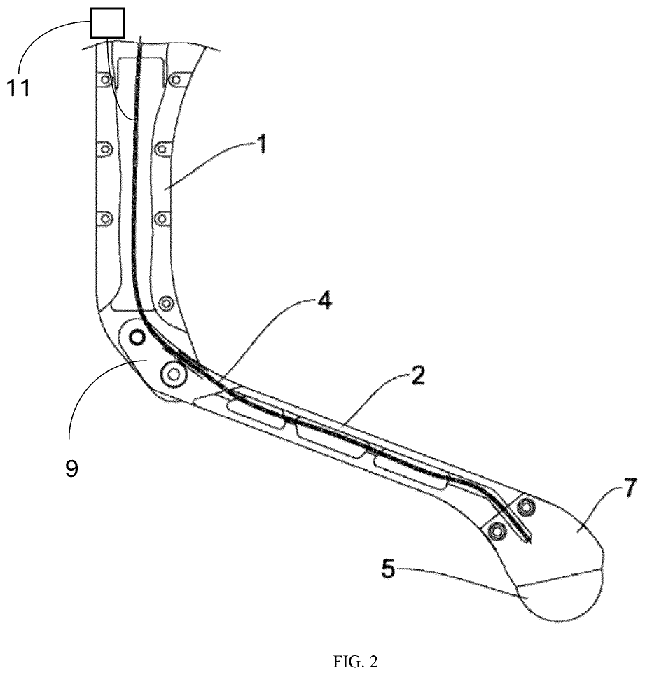

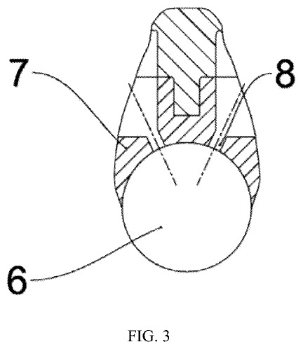

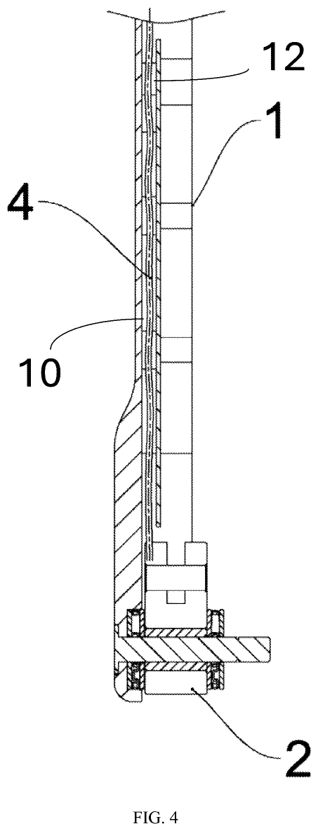

Referring to FIG. 1 to FIG. 4, a novel foot force acquisition apparatus includes a first connecting rod 1, a pressure signal acquisition board 11 provided on the first connecting rod 1, a second connecting rod 2 rotatably connected with the first connecting rod 1, and an air tube 4 provided in the first connecting rod 1 and the second connecting rod 2. The air tube 4 is an elastic hose. An end portion of the second connecting rod 2 is fixedly provided with an elastic foot pad 5. An air chamber 6 is provided in the elastic foot pad 5. One end of the air tube 4 is communicated with the air chamber 6, and the other end bypasses a rotating connection between the first connecting rod 1 and the second connecting rod 2 and is connected with the pressure signal acquisition board 11. When the elastic foot pad 5 contacts the ground to deform and squeeze the air chamber 6, the pressure signal acquisition board 11 measures the change of the internal pressure value of the air chamber 6 through the air tube 4 to realize the signal acquisition of the force on the elastic foot pad 5, and then the force on the elastic foot pad 5 may be obtained according to the change of the air pressure value. The pressure signal acquisition board 11 may also be provided on other parts fixedly connected with the first connecting rod 1.

The arrangement of the air tube 4 in the present application is as follows:
In the above embodiment, the air tube 4 is provided along the first connecting rod 1 and the second connecting rod 2. The air tube 4 spans a rotating joint 9 formed by the first connecting rod 1 and the second connecting rod 2. The pressure signal acquisition board 11 is provided on the first connecting rod 1 or other components connected with the first connecting rod 1. The air tube 4 is used to directly span the rotating joint 9 (knee joint), thus preventing the electrical cable that is more prone to fatigue damage from spanning the rotating joint 9, and improving the reliability. The air tube 4 and the air chamber 6 are in an integrated or split structure. The air tube 4 and the air chamber 6 are capable of being filled with gas or liquid. The filler in the air tube 4 and the air chamber 6 may be selected according to the actual working temperature, the detected force and the like.

An end portion of the second connecting rod 2 is provided with a foot pad mounting base 7. The elastic foot pad 5 is fixedly provided on the foot pad mounting base 7. The elastic foot pad 5 and the foot pad mounting base 7 are directly and fixedly connected or integrally formed. The elastic foot pad and the foot pad mounting base may be assembled together in advance to form a foot assembly, which is then fixedly connected to the second connecting rod to facilitate mounting and replacement. A tube groove 8 for placing the air tube 4 is provided in the foot pad mounting base 7. The tube groove 8 is provided in the foot pad mounting base 7, thus facilitating the communication between the air tube 4 and the air chamber 6. In addition, the tube channel 8 is symmetrically provided in the foot pad mounting base 7, and the tube channel 8 may be selected according to the mounting needs.

The second connecting rod 2 and the first connecting rod 1 are provided with a mounting groove 10 or a mounting cavity for placing the air tube 4. The air tube 4 is easy to swing with the rotation of the second connecting rod 2 relative to the first connecting rod 1. After multiple reciprocating swings, the air tube 4 is easy to move. Therefore, a mounting groove 10 is provided to fix the air tube 4.

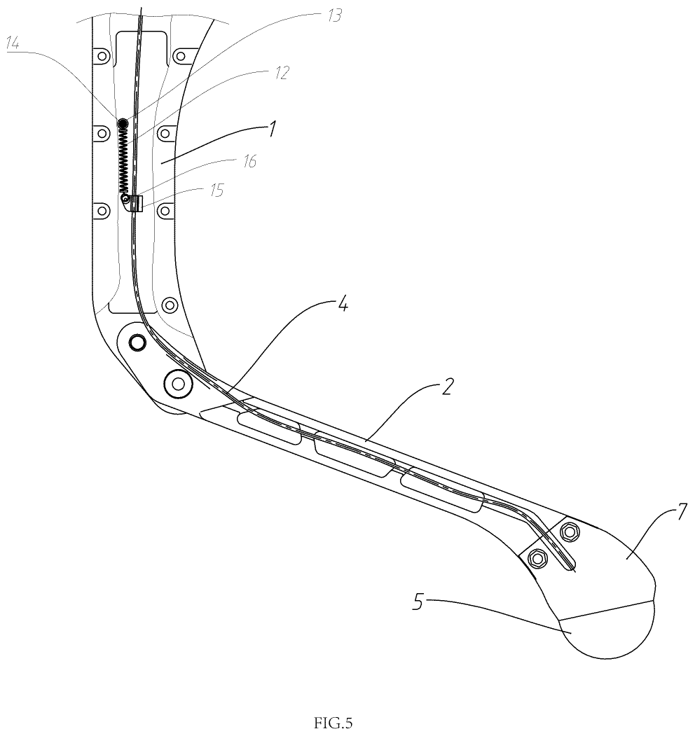

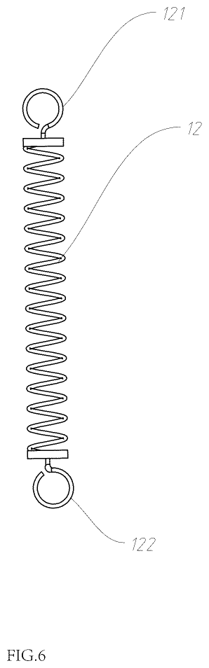

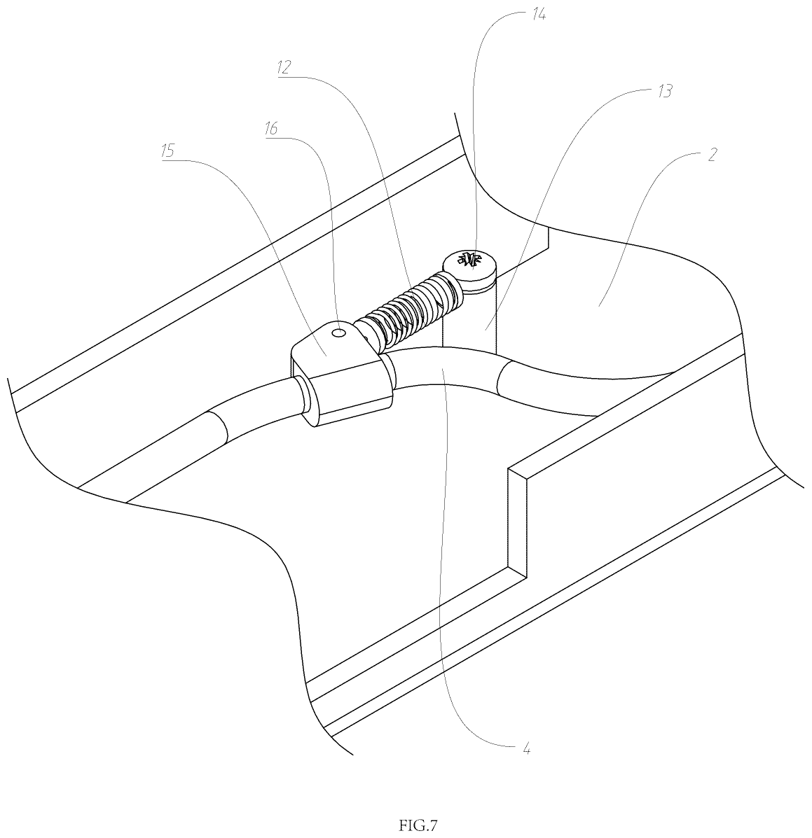

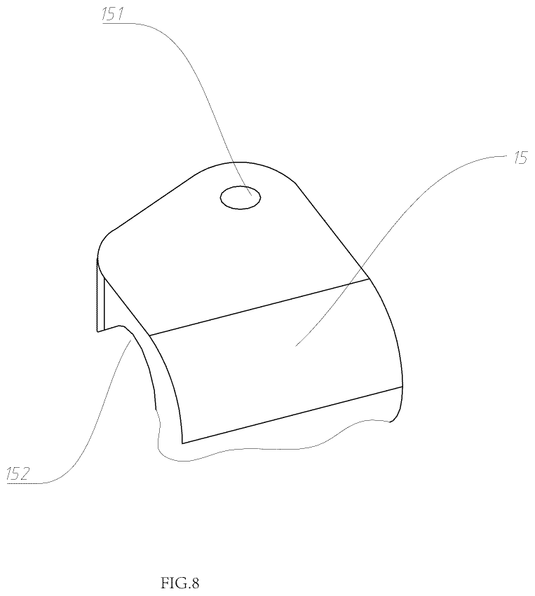

Referring to FIG. 5 to FIG. 8, a second specific embodiment of a foot force acquisition apparatus according to the present utility model is as follows:
An elastic member 12 capable of pulling the air tube 4 is arranged in the first connecting rod 1 or the second connecting rod 2. One end of the elastic member 12 is bonded, clamped, screwed, pressed, or pinned together with the first connecting rod 1, and the other end of the elastic member 12 is bonded, clamped, screwed, pressed, or pinned together with the air tube 4, or one end of the elastic member 12 is bonded, clamped, screwed, pressed, or pinned together with the second connecting rod 2, and the other end of the elastic member 12 is bonded, clamped screwed, pressed, or pinned together with the air tube 4. So that a portion of the air tube 4 located at the rotating joint 9 is always kept in a tensioned state during the rotation of the second connecting rod 2 relative to the first connecting rod 1. The elastic member 12 is provided, so that the air tube 4 is always kept in a regular tensioned state during the rotation of the second connecting rod 2 relative to the first connecting rod 1, rather than randomly twists or shakes, the structure is simple and reliable, and the fatigue life of the air tube 4 spanning the rotating joint 9 is further improved. The elastic member 12 is a tension spring, a compression spring, a torsion spring, elastic silica gel or elastic plastic.

The Second embodiment of elastic member additionally provided in the present application:
A novel foot force acquisition apparatus includes a first connecting rod 1, a pressure signal acquisition board 11, a second connecting rod 2 rotatably connected with the first connecting rod 1, and an air tube 4; an end portion of the second connecting rod 2 is fixedly provided with an elastic foot pad 5, the elastic foot pad 5 is provided with an air chamber 6, one end of the air tube 4 is communicated with the air chamber 6, and the other end is connected with the pressure signal acquisition board 11; the elastic foot pad 5 contacts the ground to deform and squeeze the air chamber 6, the pressure signal acquisition board 11 measures the change of the internal pressure value of the air chamber 6 through the air tube 4, so as to realize the signal acquisition of the force on the elastic foot pad 5;
a mounting groove 10 or mounting cavity for placing the air tube 4 is provided in the first connecting rod 1 or the second connecting rod 2;
an elastic member 12 capable of pulling the air tube 4 is provided in the second connecting rod 2;
one end of the elastic member 12 is provided with a fastening ring I 121, and the other end is provided with a fastening ring II 122;
the fastening ring I 121 is fixed to an inner wall of the second connecting rod 2 through a screwing column 13 and a screwing member 14;
a blind hole with a thread is provided in the screwing column 13, and the screwing column 13 is integrally formed with the second connecting rod 2;
the screwing member 14 includes a large end and a small end;
the large end has a diameter larger than the diameter of the fastening ring I 121, and is used for limiting the fastening ring;
the small end is a rod-shaped structure, is provided with a thread on an outer wall surface, and has a diameter smaller than the diameter of the fastening ring I 121, so that the small end of the screwing member 14 is capable of passing through the fastening ring I 121 and being tightened in the blind hole of the screwing column 13 to form a fixing structure I used for fixing one end of the elastic member 12 to the second connecting rod 2;
the fastening ring II 122 is fixed to the air tube 4 through a bent body 15 and a pinning member 16;
the bent body 15 is a sheet-like structure, and after bending, forms a wrapping cavity 152 for wrapping the air tube 4 and an assembling space for assembling the fastening ring II 122; two pinning holes 151 capable of running through each other are provided in an edge of the sheet-like structure, and include a perforation hole I and a perforation hole II;
the pinning member includes a large end and a column body, and the large end has a diameter larger than the diameter of the perforation hole I;
The pinning member 16 sequentially passes through the perforation hole I, the fastening ring II 122 and the perforation hole II by riveting to form a fixing structure II used for fixing the other end of the elastic member 12 to the air tube 4.

Or, an outer wall surface of the column body 16 is provided with a thread, and the column body has a diameter respectively smaller than the diameters of the perforation hole I, the fastening ring II 122 and the perforation hole II;
the column body sequentially passes through the perforation hole I, the fastening ring II 122 and the perforation hole II, and a nut is screwed onto an outer wall surface of the perforation hole II to form a fixing structure II used for fixing the other end of the elastic member 12 to the air tube 4, so that a portion of the air tube 4 located at the rotating joint 9 is kept always in a tensioned state during the rotation of the second connecting rod 2 relative to the first connecting rod 1.

A third specific embodiment of a foot force acquisition apparatus according to the present utility model is as follows:
A novel foot force acquisition apparatus includes a first connecting rod 1, a pressure signal acquisition board 11, a second connecting rod 2 rotatably connected with the first connecting rod 1, and an air tube 4; an end portion of the second connecting rod 2 is fixedly provided with an elastic foot pad 5, the elastic foot pad 5 is provided with an air chamber 6, one end of the air tube 4 is communicated with the air chamber 6, and the other end is connected with the pressure signal acquisition board 11; the elastic foot pad 5 contacts the ground to deform and squeeze the air chamber 6, the pressure signal acquisition board 11 measures the change of the internal pressure value of the air chamber 6 through the air tube 4, so as to realize the signal acquisition of the force on the elastic foot pad 5;
a mounting groove 10 or mounting cavity for placing the air tube 4 is provided in the first connecting rod 1 or the second connecting rod 2;
an elastic member 12 capable of pulling the air tube 4 is provided in the second connecting rod 2, one end of the elastic member 12 is bonded to the second connecting rod 2 through a first adhesive tape, and the other end of the elastic member 12 is bonded to the air tube 4 through a second adhesive tape, so that a portion of the air tube 4 located at the rotating joint is kept always in a tensioned state during the rotation of the second connecting rod 2 relative to the first connecting rod 1;
the first adhesive tape is a sheet-like structure, one part of an adhesive surface of the first adhesive tape is capable of being bonded to an outer surface of the elastic member 12 to form a wrapping structure I, and the other part of the adhesive surface of the first adhesive tape is capable of being bonded to an inner wall surface of the second connecting rod 2 to form a fixing structure I used for fixing one end of the elastic member 12;
the second adhesive tape is a sheet-like structure, one part of an adhesive surface of the second adhesive tape is capable of being bonded to the outer surface of the elastic member 12 to form a wrapping structure II, and the other part of the adhesive surface of the second adhesive tape is capable of being bonded to an outer wall surface of the air tube to form a fixing structure II used for fixing the other end of the elastic member 12.

Embodiment of compact structure in the present application:
A novel foot force acquisition apparatus includes a second connecting rod 2 and an air tube 4. An end portion of the second connecting rod 2 is fixedly provided with an elastic foot pad 5. The elastic foot pad 5 is provided with an air chamber 6. One end of the air tube 4 is communicated with the air chamber 6. The elastic foot pad 5 contacts the ground to deform and squeeze the air chamber 6, so as to realize the signal acquisition of the force on the elastic foot pad 5.

In the present application, since the air chamber is provided in the foot and the internal pressure value of the air chamber is acquired through the air tube, there is no need to provide a sensor in the foot, thus reducing the probability of sensor failure. Since the air tube is used for pressure signal acquisition and transmission, the foot and the second connecting rod do not need any electronic circuit at all, thus avoiding cable wear that influences the acquisition and transmission of pressure signals. Relatively, the signal acquisition in the present application is more reliable and stable. Further provided is an embodiment of a quadruped robot, which includes the novel foot force acquisition apparatus.

The above embodiments are only the preferred embodiments of the present application and should not be intended to limit the scope of protection of the present application. Any non-substantive changes and replacements made by those skilled in the art on the basis of the present application still fall within the scope of protection of the present application.

1-10. (canceled)

11. A foot force acquisition apparatus, comprising a first connecting rod, a pressure signal acquisition board provided on the first connecting rod, a second connecting rod rotatably connected with the first connecting rod, a rotating joint formed between the first connecting rod and the second connecting rod, and an air tube;
wherein an end portion of the second connecting rod is fixedly provided with an elastic foot pad, the elastic foot pad is provided with an air chamber, one end of the air tube is communicated with the air chamber, and the other end of the air tube is connected to the pressure signal acquisition board provided on the first connecting rod; the elastic foot pad contacts the ground to deform and squeeze the air chamber, and the pressure signal acquisition board measures the change of the internal pressure value of the air chamber through the air tube;
wherein an elastic member capable of pulling the air tube is provided in the first connecting rod or the second connecting rod, one end of the elastic member is provided with a fastening ring I, and the other end is provided with a fastening ring II;
the fastening ring I is fixed to an inner wall of the second connecting rod through a screwing column and a screwing member;
a blind hole with a thread is provided in the screwing column, and the screwing column is integrally formed with the second connecting rod;
the screwing member comprises a large end and a small end;
the large end has a diameter larger than the diameter of the fastening ring I, and is used for limiting the fastening ring;
the small end is a rod-shaped structure, is provided with a thread on an outer wall surface, and has a diameter smaller than the diameter of the fastening ring 1, so that the small end of the screwing member is capable of passing through the fastening ring I and being tightened in the blind hole of the screwing column to form a fixing structure I used for fixing one end of the elastic member to the second connecting rod;
the fastening ring II is fixed to the air tube through a bent body and a pinning member;
the bent body is a sheet-like structure, and after bending, forms a wrapping cavity for wrapping the air tube and an assembling space for assembling the fastening ring II; two pinning holes capable of running through each other are provided in an edge of the sheet-like structure, and comprise a perforation hole I and a perforation hole II;
the pinning member comprises a large end and a column body, and the large end has a diameter larger than the diameter of the perforation hole I;
the pinning member sequentially passes through the perforation hole I, the fastening ring II and the perforation hole II by riveting to form a fixing structure II used for fixing the other end of the elastic member to the air tube;
or, an outer wall surface of the column body is provided with a thread, and the column body has a diameter respectively smaller than the diameters of the perforation hole I, the fastening ring II and the perforation hole II;
the column body sequentially passes through the perforation hole I, the fastening ring II and the perforation hole II, and a nut is screwed onto an outer wall surface of the perforation hole II to form a fixing structure II used for fixing the other end of the elastic member to the air tube, so that a portion of the air tube located at the rotating joint is kept always in a tensioned state during the rotation of the second connecting rod relative to the first connecting rod.

12. The foot force acquisition apparatus according to claim 11, wherein an end portion of the second connecting rod is provided with a foot pad mounting base and the elastic foot pad is fixedly provided on the foot pad mounting base.

13. The foot force acquisition apparatus according to claim 12, wherein the air tube is provided along the first connecting rod and the second connecting rod, and the air tube spans the rotating joint formed between the first connecting rod and the second connecting rod; the pressure signal acquisition board is provided on the first connecting rod.

14. The foot force acquisition apparatus according to claim 13, wherein the air tube and the air chamber are in an integrated or split structure; the air tube and the air chamber are capable of being filled with gas or liquid.

15. The foot force acquisition apparatus according to claim 14, wherein a tube groove for placing the air tube is provided in the foot pad mounting base.

16. The foot force acquisition apparatus according to claim 11, wherein the first connecting rod or the second connecting rod is provided with a mounting groove or a mounting cavity for placing the air tube.

17. A novel foot force acquisition apparatus, wherein
the novel foot force acquisition apparatus comprises a first connecting rod, a pressure signal acquisition board, a second connecting rod rotatably connected with the first connecting rod, and an air tube; an end portion of the second connecting rod is fixedly provided with an elastic foot pad, the elastic foot pad is provided with an air chamber, one end of the air tube is communicated with the air chamber, and the other end is connected with the pressure signal acquisition board; the elastic foot pad contacts the ground to deform and squeeze the air chamber, the pressure signal acquisition board measures the change of the internal pressure value of the air chamber through the air tube, so as to realize the signal acquisition of the force on the elastic foot pad;
a mounting groove or mounting cavity for placing the air tube is provided in the first connecting rod or the second connecting rod;
an elastic member capable of pulling the air tube is provided in the second connecting rod, one end of the elastic member is bonded to the second connecting rod through a first adhesive tape, and the other end of the elastic member is bonded to the air tube through a second adhesive tape, so that a portion of the air tube located at the rotating joint is kept always in a tensioned state during the rotation of the second connecting rod relative to the first connecting rod;
the first adhesive tape is a sheet-like structure, one part of an adhesive surface of the first adhesive tape is capable of being bonded to an outer surface of the elastic member to form a wrapping structure I, and the other part of the adhesive surface of the first adhesive tape is capable of being bonded to an inner wall surface of the second connecting rod to form a fixing structure I used for fixing one end of the elastic member;
the second adhesive tape is a sheet-like structure, one part of an adhesive surface of the second adhesive tape is capable of being bonded to the outer surface of the elastic member to form a wrapping structure II, and the other part of the adhesive surface of the second adhesive tape is capable of being bonded to an outer wall surface of the air tube to form a fixing structure II used for fixing the other end of the elastic member.

18. The foot force acquisition apparatus according to claim 11, wherein the elastic member is a tension spring, a compression spring, a torsion spring, elastic silica gel or elastic plastic.

19. A foot force acquisition apparatus, comprising a connecting rod and an air tube, an end portion of the connecting rod is fixedly provided with an elastic foot pad, the elastic foot pad is provided with an air chamber, and one end of the air tube is communicated with the air chamber; the elastic foot pad contacts the ground to deform and squeeze the air chamber.
